(19) United States
(12) Patent Application Publication
(10) Pub. No.: US 2025/0342363 A1
(43) Pub. Date: Nov. 6, 2025

(54) METHOD, APPARATUS AND ELECTRONIC DEVICE FOR TRAINING A REINFORCEMENT LEARNING MODEL

(71) Applicant: Horizon Robotics Inc., Cupertino, CA (US)

(72) Inventors: Haichao ZHANG, Cupertino, CA (US); Yuwei FU, Cupertino, CA (US); Wei XU, Cupertino, CA (US)

(73) Assignee: Horizon Robotics Inc., Cupertino, CA (US)

(21) Appl. No.: 18/653,330

(22) Filed: May 2, 2024

(51) Int. Cl. G06N 3/092

(52) U.S. Cl. CPC G06N 3/092

(57) ABSTRACT

Disclosed are a method, apparatus, and electronic device for training a reinforcement learning model, relating to the field of computer vision, the method includes determining a task instruction for instructing an agent to perform a target task; determining a plurality of data information sets and a plurality of first state images generated during the performing of the target task by the agent; adjusting weight parameters for a reward model based on the task instruction and the plurality of first state images; and adjusting policy parameters for a first reinforcement learning model based on the adjusted the reward model and the plurality of data information set.

### FIELD OF THE INVENTION

The present disclosure relates to the computer vision technology, in particular, to a method, apparatus, and electronic device for training a reinforcement learning model.

### BACKGROUND OF THE INVENTION

At present, Reinforcement Learning (RL) technology is widely used in the field of computer vision. Reinforcement learning is a method of constantly learning the optimal policy through interactions of an agent with the environment. In the process of reinforcement learning, the agent may get a corresponding reward value after performing an action, and the accuracy of the reward value may have a direct impact on an effect of reinforcement learning. If a reward function is not reasonably designed, it may result in that the agent is not able to learn a correct policy, or the learned policy is not the optimal policy.

### SUMMARY OF THE INVENTION

Generally, for various usage scenarios of reinforcement learning, corresponding reward functions may be designed by a research and development personnel, which leads to a more complicated design of reward functions for complex application scenarios; and if the reward function is not designed properly, it may result in that the agent cannot learn a correct policy or the learned policy is not the optimal policy.

In order to solve the above technical problems, the present disclosure provides a method, apparatus, and electronic device for training a reinforcement learning model, which may solve the problem of an improper design of a reward function resulting in an inability of an agent to learn a correct policy.

According to a first aspect of the present disclosure, there is provided a method for training a reinforcement learning model comprising: firstly, determining a task instruction for instructing an agent to perform a target task; secondly, determining a plurality of data information sets and a plurality of first state images generated during the performing of the target task by the agent; thirdly, adjusting weight parameters for a reward model based on the task instruction and the plurality of first state images; and lastly, adjusting policy parameters for a first reinforcement learning model based on the adjusted the reward model and the plurality of data information sets.

According to a second aspect of the present disclosure, there is provided an apparatus for training a reinforcement learning model comprising: a first determination module configured for determining a task instruction for instructing an agent to perform a target task; a second determination module configured for determining a plurality of data information sets and a plurality of first state images generated during the performing of the target task by the agent; a first adjusting module configured for adjusting weight parameters for a reward model based on the task instruction and the plurality of first state images; and a second adjustment module configured for adjusting policy parameters for a first reinforcement learning model based on the adjusted reward model and the plurality of data information sets.

According to a third aspect of the present disclosure, there is provided a computer-readable storage medium on which a computer program is stored, wherein the computer program is configured to implement the method for training a reinforcement learning model in accordance with the first aspect as above.

According to a fourth aspect of the present disclosure, there is provided an electronic device comprising: a processor; a memory configured for storing processor-executable instructions, wherein the processor is configured for reading the executable instruction from the memory, and executing the instruction to implement the method for training a reinforcement learning model in accordance with the first aspect as above.

According to a fifth aspect of the present disclosure, there is provided a computer program product configured for, when instructions in the computer program product are executed by a processor, performing the method for training a reinforcement learning model in accordance with the first aspect as above.

Based on the method of learning reinforcement learning model in accordance with the present disclosure, by adjusting the weight parameters for the reward model during the reinforcement learning process, the adjusted reward model may more accurately describe the process for performing the task as compared to the pre-adjusted reward model, and thus it may be ensured that a more accurate policy parameter may be learned when performing reinforcement learning based on the adjusted reward model.

### BRIEF DESCRIPTION OF THE DRAWINGS

FIG. 1 is a diagram illustrating a scenario to which the present disclosure is applicable.

FIG. 2 is a schematic diagram illustrating a reward profile for a reinforcement learning process in accordance with an exemplary embodiment of the present disclosure.

FIG. 3 is a flowchart illustrating a method for training a reinforcement learning model in accordance with an exemplary embodiment of the present disclosure.

FIG. 4 is a flowchart illustrating a method for training a reinforcement learning model in accordance with another exemplary embodiment of the present disclosure.

FIG. 5 is a schematic diagram illustrating a model structure of a reward model in accordance with an exemplary embodiment of the present disclosure.

FIG. 6 is a flowchart illustrating a method for training a reinforcement learning model in accordance with yet another exemplary embodiment of the present disclosure.

FIG. 7 is a schematic diagram illustrating a model structure of a reward model in accordance with another exemplary embodiment of the present disclosure.

FIG. 8 is a flowchart illustrating a method for training a reinforcement learning model in accordance with yet another exemplary embodiment of the present disclosure.

FIG. 9 is a flowchart illustrating a method for training a reinforcement learning model in accordance with yet another exemplary embodiment of the present disclosure.

FIG. 10 is a flowchart illustrating a method for training a reinforcement learning model in accordance with yet another exemplary embodiment of the present disclosure.

FIG. 11 is a schematic diagram illustrating a target task performing process in accordance with an exemplary embodiment of the present disclosure.

FIG. 12 is a schematic diagram illustrating a structure of an apparatus for training a reinforcement learning model in accordance with an exemplary embodiment of the present disclosure.

FIG. 13 is a schematic diagram illustrating a structure of an apparatus for training a reinforcement learning model in accordance with another exemplary embodiment of the present disclosure.

FIG. 14 is a schematic diagram illustrating a structure of an electronic device in accordance with an exemplary embodiment of the present disclosure.

### DETAILED DESCRIPTION OF THE EMBODIMENTS

For the purpose of explaining the present disclosure, exemplary embodiments of the present disclosure are described in detail below with reference to the accompanying drawings. Apparently, the described embodiments are only some, not all, of the embodiments of the present disclosure, and it should be understood that the present disclosure is not limited to the exemplary embodiments.

It should be noted that the relative arrangements, numerical expressions, and values of the components and steps set forth in these embodiments do not limit the scope of the present disclosure unless otherwise specifically stated.

### Application Overview

First, application scenarios of the present disclosure are described. The methods of reinforcement learning model in accordance with embodiments of the present disclosure may be applied to, for example, autonomous driving scenarios, robot automation control scenarios in industry, and any other implementable scenarios.

Exemplarily, an agent may constantly learn by interacting with an environment to obtain an optimal policy for performing a task. In some examples, the agent includes a device or apparatus capable of intelligently interacting with the environment, such as a vehicle (e.g., a vehicle with an autonomous driving function), a robot, a robotic arm, and the like. Embodiments of the present disclosure do not limit the types of agents.

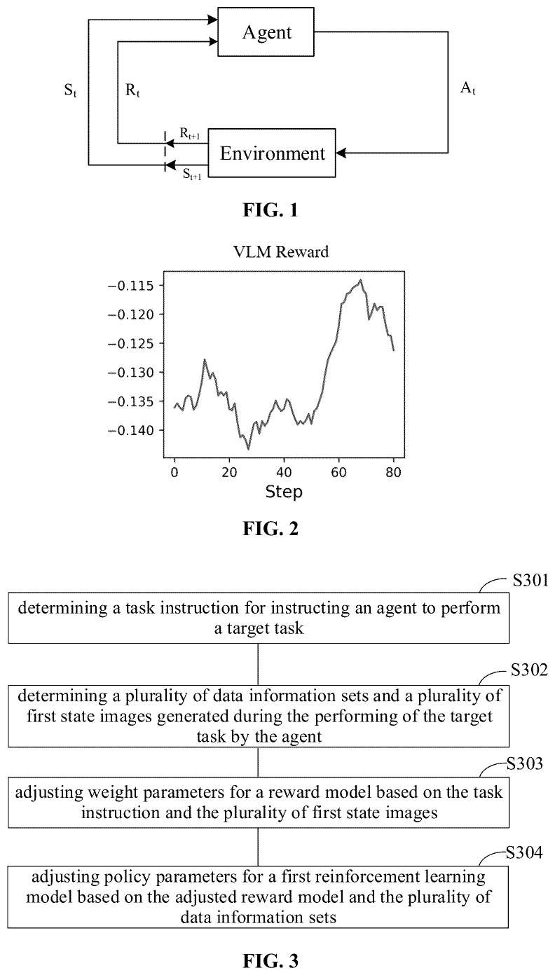

As shown in FIG. 1, when performing a task T, the agent first determines and performs an action Aₜ to be performed based on initial policy parameters and a current state of the agent, wherein the agent generates a new state Sₜ₊₁ through interacting with an environment by action Aₜ while the environment gives a reward Rₜ₊₁. Then, the agent adjusts the initial policy parameters based on the new state Sₜ₊₁ and the reward Rₜ₊₁, and determines and performs the next action Aₜ₊₁ to be performed based on the adjusted policy parameters, wherein the agent generates a new state Sₜ₊₂ through interacting with the environment by action Aₜ₊₁ while the environment gives a new reward Rₜ₊₂. Once more, the agent adjusts the policy parameters again based on the new state Sₜ₊₂ and the new reward Rₜ₊₂ (or a set of collected states and reward data), and so on, in an iterative cycle until optimal policy parameters θ for completing task T are learned by the agent. For example, the optimal policy parameters θ may be policy parameters when the cumulative reward value for performing task T reaches a preset condition.

The agent needs to constantly collect parameters such as the environmental parameters in which the agent is located and the state parameters for the agent during the interaction with the environment in order to adjust the policy parameters for the agent to perform the task. Therefore, a variety of sensors may be provided for collecting the above parameters, which may be provided on the agent or outside the agent to be electrically connected to the agent, so that the agent may acquire the environmental parameters and state parameters collected by the sensors. In some examples, the above sensors include, but are not limited to, an image sensor, a gyroscope sensor, a distance sensor, a light sensor, and a gravity sensor.

Generally, in the process of reinforcement learning, the agent may get a corresponding reward value according to a reward function after performing an action, where the accuracy of the reward value may have a direct impact on the effect of reinforcement learning. At present, for various usage scenarios of reinforcement learning, corresponding reward functions may be designed by a research and development personnel, which leads to more complicated design of reward functions for complex application scenarios; and if the reward function is too sparse (i.e., rewards are given only at a few steps, such as at the end of a final task), it may make it more difficult for the agent to learn, which may result in that the agent is not able to learn a correct policy or the learned policy is not an optimal policy.

In order to solve the problem that the design of the reward function is more complicated and the over-simplified reward function may increase the learning difficulty, a visual-language model (VLM) may be used as the reward function in the related technology. When using VLM as the reward function, a task instruction (e.g., a text instruction, i.e., language) and a latest state image (i.e., image) captured may be input into the VLM to obtain a text vector Ø_{L}(l) and an image vector Ø_{I}(oₜ); and then, a cosine similarity between the text vector Ø_{L}(l) and image vector Ø_{I}(oₜ) is calculated to obtain a VLM reward

$${r}_{t}^{VLM} .$$

The VLM reward

$${r}_{t}^{VLM}$$

may be determined based on Equation (1) below.

$${r}_{t}^{VLM} {=}^{Δ} \frac{〈 {∅}_{L} ( l ) , {∅}_{I} ( {o}_{t} ) 〉}{‖ {∅}_{L} ( l ) ‖ \cdot ‖ {∅}_{I} ( {o}_{t} ) ‖} \qquad Equation ( 1 )$$

Where oₜ denotes a-state image at a step t, and l denotes the task instruction that instructs the agent to perform the task, Ø_{L}(l) denotes the text vector, and Ø_{I}(oₜ) denotes the image vector.

Since it is easier to determine a success state and a failure state of a task during performance, when using the VLM as a reward function, in order to balance the VLM reward with a task reward, a reward value r^{t} corresponding to the step t may be determined based on the VLM reward

$${r}_{t}^{VLM}$$

and a sparse task reward

$${r}_{t}^{task} .$$

Among them, the sparse task reward

$${r}_{t}^{task}$$

has a reward value of 0 when the task fails and a reward value of 1 only when the task succeeds. The reward value r^{t} corresponding to step t may be determined according to Equation (2) below.

$${r}^{t} = {r}_{t}^{task} + ρ \cdot {r}_{t}^{VLM} \qquad Equation ( 2 )$$

Where ρ denotes a balancing parameter for balancing the VLM reward

$${r}_{t}^{VLM}$$

with the sparse task reward

$${r}_{t}^{task} .$$

Exemplarily, it is taken as an example that the task instruction for instructing the agent to perform is to press a button, and FIG. 2 shows a schematic diagram illustrating a reward curve when VLM is used as the reward function. Ideally, the reward curve should be in conformity with an expert's progress in performing the task, that is, when the state is closer to completion of the task, a corresponding reward value is higher, and so the reward value on the reward curve should gradually increase by a monotonically increasing tendency. However, as shown in FIG. 2, when VLM is used as the reward function, the reward value does not constantly increase with the performing of the task, but fluctuates up and down, and so the reward value is not strictly in conformity with the progress of the task. Therefore, the reward value determined by directly using VLM as the reward function is inaccurate, which may have an impact on the effect of the reinforcement learning and result in that the learned policy is not the optimal policy.

In order to solve the problem that the reward value determined when using VLM as a reward function in the related technology is not accurate enough, resulting in the learned policy not being the optimal policy, embodiments of the present application provide a method for training a reinforcement learning model, which constantly adjusts weight parameter for a reward model in a process of reinforcement learning, so that the adjusted reward model can more accurately represent a process of performing a task, and therefore it can be ensured that more accurate policy parameters are learned when the reinforcement learning is performed based on the adjusted reward model.

### Exemplary Method

FIG. 3 shows a flowchart illustrating a method for training a reinforcement learning model in accordance with an exemplary embodiment of the present disclosure. This embodiment may be applicable to an electronic device, and as shown in FIG. 3, the method includes the following step S301-step S304.

Step S301: determining a task instruction for instructing an agent to perform a target task.

Exemplarily, the target task performed by the agent may be various depending on a type of the agent. For example, it is taken as an example that the agent is a robotic arm, the target task performed by the agent include, but are not limited to, a button press, a door open, a drawer close, a peg insert side, a lever pull, a shelf place, a sweep, and the like. The types of the agent are not limited to the embodiments of the present disclosure, and the following embodiments are described exemplarily with the agent being a robotic arm as an example.

Illustratively, the target task may be achieved through a series of actions performed by the agent in a process of interaction with the surrounding environment. The electronic device may determine the task instruction for instructing the agent to perform the target task by receiving a speech command or a text command input from a user. The electronic device may also determine the task instruction for instructing the agent to perform the target task based on environmental parameters or state parameters for the agent. For example, the electronic device may generate a task instruction for performing the task when the environmental parameter or the state parameter satisfies a predetermined condition. The specific manner in which the electronic device determines the task instruction for instructing the agent to perform the target task do not is limited to embodiments of the present disclosure.

Step S302: determining a plurality of data information sets and a plurality of first state images generated during the performing of the target task by the agent.

A plurality of actions may be generated during the performing of the target task by the agent, and a plurality of state images may be generated through the interaction of the actions with the environment. The data information set generated during the above-described performing of the target task may include a current state image (which may also be referred to as a second state image), an action, a next state image (which may also be referred to as a first state image), and a reward value generated during the performing of the target task by the agent.

For example, if the agent is a robotic arm and the target task is button press, when the robotic arm performs the task of button press, an action A₀ may be determined according to a current state S₀ of the robotic arm; upon performing the action A₀ by the robotic arm, the agent may generate a new state image S₁ through interacting with the environment by the action A₀, while the environment may give a reward value R₁. The current state image S₀, the action A₀, the reward value R₁ and the next state image S₁ may be stored in a memory, and a set of data comprising the current state image S₀, the action A₀, the reward value R₁ and the next state image S₁ may be referred to as a data information set. In the process of performing the button press task by the robot arm, a number of data information sets generated in the process of performing the task may be constantly collected by the above method.

In some examples, a series of data information sets generated during the performing of the target task may be stored in the memory, each of data information sets including a current state image, an action, a reward value, and a next state image. During training of a model, the policy parameters for a reinforcement learning model may be iteratively adjusted based on the plurality of data information sets, and the data information sets generated during the performing of the target task may be randomly read from the memory at each iterative training. The data information set stored in the memory may be notated as {(Sᵢ, Aᵢ, Rᵢ₊₁, Sᵢ₊₁)}_{i=0 . . . N}.

Exemplarily, the first state image is a latest state image generated during the performing of the target task, which may be noted as {Sᵢ₊₁}_{i=0 . . . N}. That is, the latest state image Sᵢ₊₁ may be stored in the memory after the action Aᵢ interacts with the environment.

In some examples, when storing the first state image in the memory, a sample type corresponding to that first state image may be stored correspondingly. The sample type involves a positive sample and a negative sample, wherein a sample on a trajectory corresponding to the performing of the target task being successful may be referred to as the positive sample, and a sample on a trajectory corresponding to the performing of the target task being unsuccessful may be referred to as the negative sample.

For example, after the performing of the target task is completed, a plurality of state images Sᵢ₊₁ generated during the performing of the target task and the corresponding sample types may be stored in the memory, depending on whether the target task was performed successfully.

Step S303: adjusting weight parameters for a reward model based on the task instruction and the plurality of first state images.

Inaccuracy of a reward value may mislead a reinforcement learning, a reason why the inaccuracy of the reward value of the VLM determined by the above Equation (1) is a fact that the VLM may be a pre-trained model, and there may be differences in distributions of the images in a use scenario and training data, resulting in an unstrictly match between image vector and text vectors, resulting in that the reward function cannot accurately describe the process for performing the task. In order to ensure that the reward function may more accurately describe the process for performing the task during the reinforcement learning process, embodiments of the present application may adopt a reward model as the reward function, in which a learnable network is included, and through constantly adjusting the weight parameter for the learnable network in the reward model, so that the reward function may more accurately describe the process for performing the target task.

In some embodiments, the reward model is a visual language model with a learnable network. Exemplarily, the task instruction and the first state image may be input into the reward model as language and text, respectively, to determine a corresponding VLM reward value

$${r}_{t}^{VLM}$$

(which may also be referred to as a first reward value), and adjusting a weight parameter in the reward model based on this VLM reward value so that the adjusted reward model can more accurately describe the process for performing the task compared to the pre-adjusted reward model.

Step S304: adjusting policy parameters for a first reinforcement learning model based on the adjusted reward model and the plurality of data information sets.

After adjusting the weight parameter for the reward model, the policy parameters for the first reinforcement learning model may be further adjusted based on the adjusted reward model. Since the adjusted reward model may more accurately describe the process for performing the task, the reward value determined based on the adjusted reward model is more accurate. Therefore, when the first reinforcement learning model is trained based on the more accurate reward value, a better policy parameter may be obtained.

Exemplarily, the first reinforcement learning model may employ a VLM agent (i.e., an agent trained by reinforcement learning using VLM as well as task rewards), and the reward function corresponding to this first reinforcement learning model is related to the reward model. In some examples, a reward value for the first reinforcement learning model at step t r^{t} may be based on a sparse task reward

$${r}_{t}^{task}$$

and a VLM reward

$${r}_{t}^{VLM}$$

determined by reward optimization learning.

According to the method for training a reinforcement learning model in accordance with embodiments of the present application, the weight parameter for the reward model is constantly adjusted during the reinforcement learning process, so that the adjusted reward model can more accurately describe the process for performing the task, and thus it can be ensured, by performing reinforcement learning based on the adjusted reward model, that more accurate policy parameters are learned.

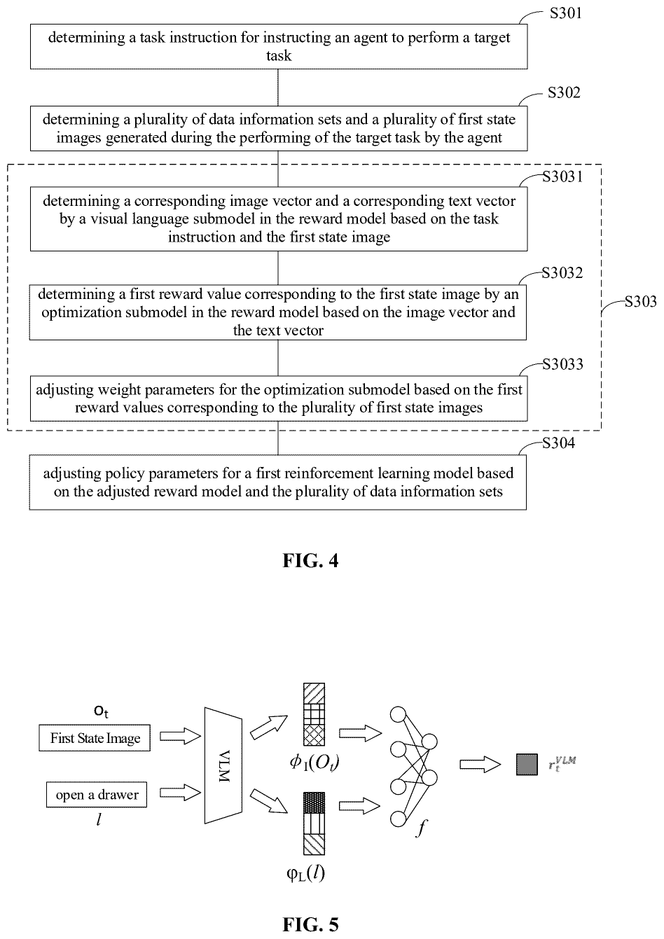

As shown in FIG. 4, based on the embodiment shown in FIG. 3 above, step S303 may include step S3031-step S3033 as follows.

Step S3031: determining a corresponding image vector and a corresponding text vector by a visual language submodel in the reward model based on the task instruction and the first state image.

Exemplarily, the reward model includes a visual language submodel. The task instruction and the first state image may be processed by the visual language submodel in the reward model, to obtain corresponding image vector and text vector, and the embodiments of the present disclosure do not limit the specific model structure of the visual language submodel.

As shown in FIG. 5, it is taken as example that the task instruction l is to open a drawer and the visual language submodel is a VLM, and the image vector Ø_{I}(oₜ) and text vector Ø_{L}(l) may be obtained by inputting the task instruction I and the first state image oₜ into the VLM.

In some embodiments, the visual language submodel may be a pre-trained VLM, and a model parameter for this visual language submodel may not be adjusted when adjusting the weight parameter for the reward model. That is, a weight parameter for the visual language submodel in the reward model may not be adjusted in embodiments of the present disclosure, and it is possible to adjust only weight parameters for an optimization submodel in the reward model.

Step S3032: determining a first reward value corresponding to the first state image by an optimization submodel in the reward model based on the image vector and the text vector.

The first state image is a new state image generated by the agent after interacting with the environment, and the first reward value corresponding to the first state image indicates a VLM reward

$${r}_{t}^{VLM}$$

given by the environment when the agent generates this new state image.

Exemplarily, the reward model may further include an optimization submodel, which is a learning network f with learnable parameters, wherein the weight parameter for the optimization submodel may be initialized in an initial state, and the image vector and the text vector are optimized by the optimization submodel in order to obtain a first reward value corresponding to the first state image. This first reward value may also be referred to as the VLM reward

$${r}_{t}^{VLM} .$$

In some examples, the optimization submodel may include two small learnable networks f_{wL} and f_{wI}. The weight parameter for the reward model may be constantly adjusted through the two small learnable networks f_{WL} and f_{wI}, such that the adjusted reward model may more accurately describe the process for performing the target task (which may also be referred to as reward alignment). That is, the reward value determined according to the adjusted reward model is more accurate.

It is to be understood that the first reward values corresponding to the respective first state images may be determined by the above step S3031-step S3032, and after the first reward values corresponding to the respective ones of the plurality of first state images are obtained, the method proceeds to step S3033 to adjust the weighting parameters for the reward model.

Step S3033: adjusting weight parameters for the optimization submodel based on the first reward values corresponding to the plurality of first state images.

Exemplarily, ideally, when the agent performs the target task, the reward value for the generated first state image should be higher when the task is closer to a completion state. That is, the reward value corresponding to the first state image should gradually increase by a monotonically increasing tendency during the performing of the target task. However, due to the inaccuracy of the reward function, the reward value corresponding to the first state image does not increase by a monotonically increasing tendency during the performing of the task. Therefore, according to embodiments of the present disclosure, the weight parameter for the optimization submodel may be constantly adjusted according to the first reward values corresponding to the plurality of first state images during the performing of the task, so that the reward value determined by the adjusted reward model is more accurate.

According to the embodiments of the present disclosure, through constantly adjusting the weight parameter for the optimization submodel in the reward model, the reward model may become more and more accurate as the task progresses, so that the adjusted reward model can more accurately describe the process for performing the task relative to the reward model without being adjusted, even though the reward model is not accurate enough in the initial state.

According to the method for training a reinforcement learning model in accordance with embodiments of the present application, through constantly adjusting the weight parameter for the optimization submodel in the reward model in the process of reinforcement learning, the adjusted reward model may more accurately describe the process for performing the target task, and thus it may be ensured that more accurate policy parameters are learned when performing reinforcement learning based on the adjusted reward model. Furthermore, because the number of parameters to be learned in the optimization submodel is less, the learning efficiency may be further improved.

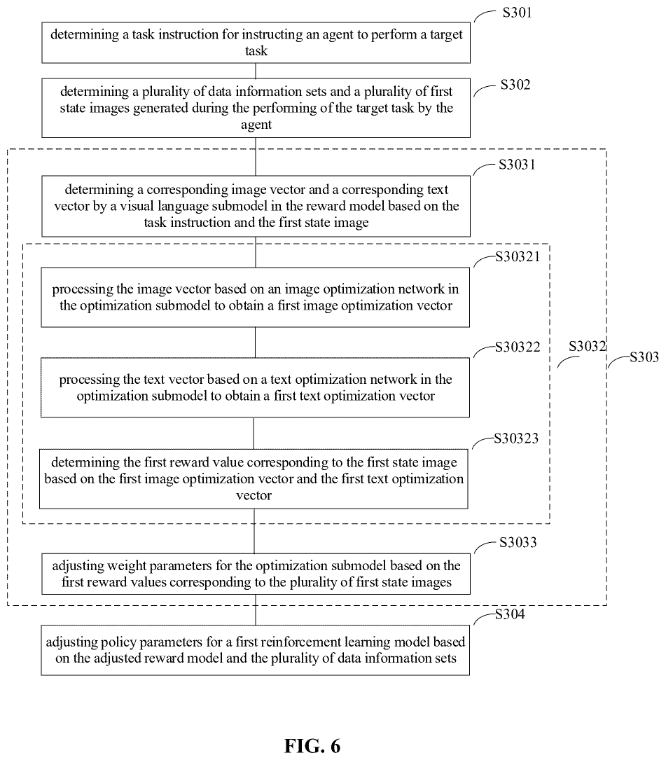

As shown in FIG. 6, based on the embodiment shown in FIG. 4 above, step S3032 may include step S30321-step S30323 below. A first reward values corresponding to the respective first state images may be determined by step S30321-step S30323.

Step S30321: processing the image vector based on an image optimization network in the optimization submodel to obtain a first image optimization vector.

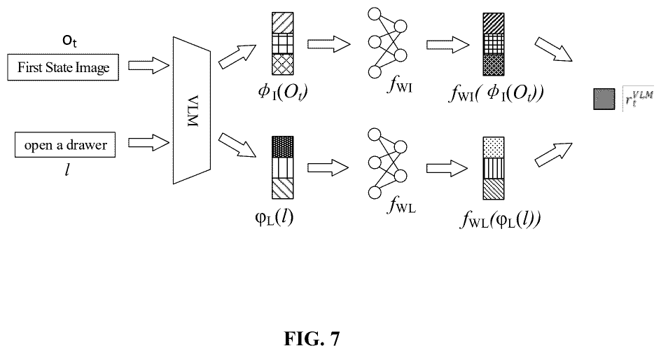

Exemplarily, the optimization submodel may include a learnable image optimization network f_{WI}. As shown in FIG. 7, the image vector Ø_{I}(oₜ) obtained through the VLM may be further processed through the image optimization network f_{WI} to obtain a first image optimization vector f_{WI}(ϕ₁(Oₜ)).

Step S30322: processing the text vector based on a text optimization network in the optimization submodel to obtain a first text optimization vector.

Exemplarily, the optimization submodel may include a learnable text optimization network f_{WL}. As shown in FIG. 7, the text vector Ø_{L}(l) obtained through the VLM may be further processed through the text optimization network f_{WL} to obtain a first text optimization vector f_{WL} (Ø_{L}(l)).

That is to say, the optimization submodel in an embodiment of the present application may include two small networks for learning, namely, the image optimization network f_{WI} and the text optimization network f_{WL}, through which the text vector and the image vector generated through the visual language submodel VLM may be optimized, respectively, so as to ensure that there is a better match between the image and the text, and the generated reward values are more accurate.

In some examples, the above-described image optimization network f_{WI} and the text optimization network f_{WL} may be two simple two-layer neural networks (e.g., Multilayer Perceptron), respectively. Because the number of learnable weight parameters in the image optimization network f_{WI} and the text optimization network f_{WL} are less, as compared to the weight parameters adjusted for the VLM model, the learning efficiency may be further improved by adjusting the weight parameters for the optimization submodel according to the embodiments of the present disclosure.

Step S30323: determining the first reward value corresponding to the first state image based on the first image optimization vector and the first text optimization vector.

Exemplarily, after the first image optimization vector f_{WI}(Φ_{I}(Oₜ)) and the first text optimization vector f(_{WLL}(l)) are determined, a cosine similarity between the first image optimization vector f_{WI}(Φ_{I}(O)) and the first text optimization vector f_{WL}(Φ_{L}(l)) may be calculated to obtain the first reward value

$${r}_{t}^{VLM}$$

corresponding to the first state image.

The first reward value corresponding to the first state image

$${r}_{t}^{VLM}$$

may be determined according to Equation (3) below.

$${r}_{t}^{VLM} {=}^{Δ} \frac{( {f}_{WL} ( {∅}_{L} ( l ) ) , {f}_{WI} ( {∅}_{I} ( {o}_{t} ) ) 〉}{‖ {f}_{WL} ( {∅}_{L} ( l ) ) ‖ \cdot ‖ {f}_{WI} ( {∅}_{I} ( {o}_{t} ) ) ‖} \qquad Equation ( 3 )$$

According to the method for training a reinforcement learning model in accordance with embodiments of the present disclosure, the image vector and the text vector determined by the VLM are optimized through the two learnable neural networks, namely, the image optimization network and the text optimization network, respectively, it can be ensured that the optimized image optimization vector and text optimization vector are matched better, and therefore the reward values determined based on the image optimization vector and the text optimization vector are more accurate.

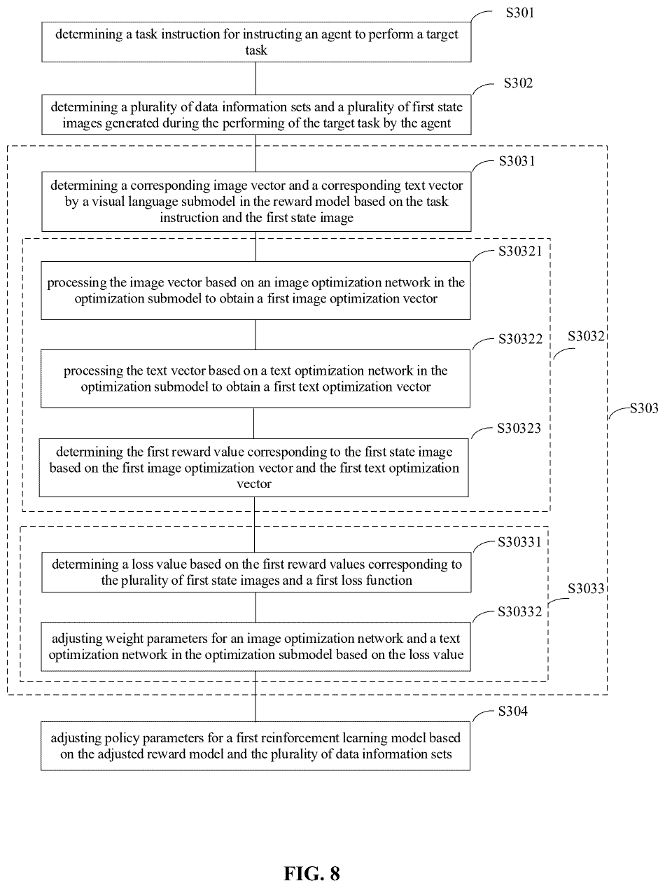

As shown in FIG. 8, based on the embodiment shown in FIG. 4 above, step S3033 may include step S30331-step S30332 as follows.

Step S30331: determining a loss value based on the first reward values corresponding to the plurality of first state images and a first loss function.

Exemplarily, after the first reward values corresponding to the respective ones of the first state images are determined, a first reward value corresponding to a first state image generated later should be greater than a first reward value corresponding to a first state image generated earlier, since the first state image generated later is closer to a completion state of the task than the first state image generated earlier in the process of the preforming of the target task. However, due to the inaccuracy of the reward function (e.g., the reward model), it is possible that the first reward value corresponding to the first state image generated later is smaller than the first reward value corresponding to the first state image generated earlier. Therefore, in order to improve the accuracy of the reward model, the loss value may be further determined based on the first reward values corresponding to the plurality of first state images and the first loss function.

In some embodiments, when determining the loss value based on the first reward values corresponding to the plurality of first state images and the first loss function, a sample type of each of the first state images may be determined first; and then the first reward values may be further compared based on the sample type of each of the first state images to determine the loss value.

Exemplarily, the sample type of the first state image is used to indicate that the first state image is a state image corresponding to a successful trajectory or a state image corresponding to an unsuccessful trajectory. The sample type of the first state image includes a first sample type and a second sample type, where the first sample type is used to indicate that the first state image is a state image corresponding to a successful trajectory and the second sample type is used to indicate that the first state image is a state image corresponding to an unsuccessful trajectory.

From a start of the performing of the target task by the agent to an end of the performing of the target task, the target task may be performed successfully or may not be performed successfully. When the performing of the target task is successful, the sample types of the set of first state images generated during the performing of the target task are all the first sample type; and when the target task is not successfully performed, the sample types of the set of first state images generated during the performing of the target task are all the second sample types.

Exemplarily, when the target task ends, the sample types of the set of the first state images generated during the performing of the target task may be marked according to whether the target task is performed successfully, and the set of first state images and the sample type corresponding to the respective first state images may be stored in the memory.

When performing step S30331, the plurality of first state images and the sample types corresponding to the respective first state images may be read from the memory, wherein the plurality of first state images may each have the first sample types or each have the second sample types, and a part of the first state images may have the first sample types and another part of the first state images may have the second sample types. When the sample types of the plurality of first state images include both the first sample type and the second sample type, the first state images corresponding to the different sample types may be first state images generated when the target task is performed by the agent once, or may be first state images generated when the target task is performed by the agent multiple times.

In the case where the plurality of first state images include both a first image with a first sample type and a second image with a second sample type, a first magnitude relationship between the first reward value corresponding to the first image and the first reward value corresponding to the second image may be determined, and a the first sub-loss value may be determined by a first sub-loss function in the first loss function based on the first magnitude relationship.

Exemplarily, first state images of the first sample types generated from a successful trajectory τ^{p} with performing of a target task being successful may be referred to as positive samples, and the positive sample may be represented by O^{p}; first state images of the second sample types generated from an unsuccessful trajectory with the performing of the target task being unsuccessful may be referred to as negative samples, and the negative samples may be represented by τⁿ. That is, a state image of the first sample type (e.g., the first image) may be represented by O^{p}, and a state image (e.g., the second image) of the second sample type may be represented by Oⁿ. If the positive samples O^{p} and the negative samples Oⁿ are the state images generated when the agent performs the target task, then the positive samples O^{p} are state images corresponding to the successful performing of the target task, and the negative samples Oⁿ are state images corresponding to the unsuccessful performing of the target task. Since the reward values during the performing of the target task should be monotonically increasing, the reward value for the positive sample O^{p} should be higher than that of the negative sample Oⁿ. Therefore, the first sub-loss value [symbol] _{pos-neg} may be calculated according to the reward value for the positive sample O^{p} and the reward value for the positive sample Oⁿ.

The value of the first sub-loss [symbol] _{pos-neg} may be determined by Equation (4) and Equation (5) below.

$${ℒ}_{p o s - n e g} = \begin{matrix}E \\ \{ {O}^{p} ∈ {τ}^{p} , {O}^{n} ∈ {τ}^{n} \}\end{matrix} {ℓ}_{δ} ( {O}^{p} , {O}^{n} ) \qquad Equation ( 4 )$$

$${ℓ}_{δ} ( {O}^{p} , {O}^{n} ) {=}^{Δ} max ( 0 , {r}^{VLM} ( {O}^{n} ) - {r}^{VLM} ( {O}^{p} ) + δ ) \qquad Equation ( 5 )$$

Where r^{VLM}(Oⁿ) denotes the reward value for the negative sample Oⁿ, and r^{VLM}(O^{p}) denotes the reward value for the positive sample O^{p}, and δ denotes a boundary loss. When the reward value r^{VLM}(Oⁿ) for the negative sample Oⁿ is higher than, by δ, the reward value r^{VLM}(O^{p}) for the positive sample O^{p}, no loss may occur, otherwise a loss may occur.

For example, when a difference between the reward value r^{VLM}(O^{p}) for the positive sample O^{p} and the reward value r^{VLM}(Oⁿ) for the negative sample Oⁿ is greater than 8, no loss (i.e., the loss value is 0) may occur; and when difference between the reward value r^{VLM}(O^{p}) for the positive sample O^{p} and the reward value r^{VLM}(Oⁿ) for the negative sample Oⁿ is less than 8, the loss may occur (i.e., the loss value is not 0). The first sub-loss value [symbol] _{pos-neg} may be calculated by the above Equation (4).

In the case where the plurality of first state images includes a third image and a fourth image whose sample types are both first sample types, a second magnitude relationship between the first reward value corresponding to the third image and the first reward value corresponding to the fourth image may be determined, and a second sub-loss value may be determined by a second sub-loss function in the first loss function based on the second magnitude relationship.

Exemplarily, the third image and the fourth image, both of which have the first sample types, may be the first state images generated from the same success trajectory τ^{p}, that is, the third image and the fourth image are positive samples. It is taken as an example that the third image is a positive sample

$${O}_{i}^{p}$$

and the fourth image is a positive sample

$${O}_{i - k}^{p} .$$

Since the positive sample

$${O}_{i}^{p}$$

is closer to a task success state than the positive sample

$${O}_{i - k}^{p} ,$$

the reward value for the positive sample

$${O}_{i}^{p}$$

should be higher than the reward value for the positive sample

$${O}_{i - k}^{p} .$$

### However, the

reward value for the positive sample

$${O}_{i}^{p}$$

determined according to the reward model may not be higher than the reward value for the positive sample

$${O}_{i - k}^{p} ,$$

so the second sub-loss value [symbol] ₚₒₛ₋ₚₒₛ may be determined by comparing the reward value for the positive sample

$${O}_{i}^{p}$$

and the reward value for the positive sample

$${O}_{i - k}^{p} .$$

The value of the second sub-loss [symbol] ₚₒₛ₋ₚₒₛ may be determined by Equation (6) and Equation (7) below.

$${ℒ}_{p o s - p o s} = \begin{matrix}E \\ \{ {O}_{i - k}^{p} , {O}_{i}^{p} ∈ {τ}^{p} \}\end{matrix} {ℓ}_{δ} ( {O}_{i}^{p} , {O}_{i - k}^{p} ) \qquad Equation ( 6 )$$

$${ℓ}_{δ} ( {O}_{i}^{p} , {O}_{i - k}^{p} ) {=}^{Δ} max ( 0 , {r}^{VLM} ( {O}_{i - k}^{p} ) - {r}^{VLM} ( {O}_{i}^{p} ) + δ ) \qquad Equation ( 7 )$$

where

$${r}^{VLM} ( {O}_{i}^{p} )$$

denotes the reward value for the positive sample, and

$${r}^{VLM} ( {O}_{i - k}^{p} )$$

denotes the reward value for the positive sample

$${O}_{i - k}^{p} .$$

When the reward value

$${r}^{VLM} ( {O}_{i - k}^{p} )$$

for the positive sample

$${O}_{i - k}^{p}$$

is less than, by δ, the reward value

$${r}^{VLM} ( {O}_{i}^{p} )$$

for the positive sample

$${O}_{i}^{p} ,$$

no loss may occur, otherwise a loss may occur.

For example, when a difference between the reward value

$${r}^{VLM} ( {O}_{i}^{p} )$$

for the positive sample

$${O}_{i}^{p}$$

and the reward value

$${r}^{V L M} ( {O}_{i - k}^{p} )$$

for the positive sample

$${O}_{i - k}^{p}$$

is greater than δ no loss may occur; and when the difference between the reward value

$${r}^{V L M} ( {O}_{i}^{p} )$$

for the positive sample

$${O}_{i}^{p}$$

and the reward value

$${r}^{V L M} ( {O}_{i - k}^{p} )$$

for the positive sample

$${O}_{i - k}^{p}$$

is less than δ, a loss may occur. The second sub-loss value [symbol] ₚₒₛ₋ₚₒₛ may be calculated by the above Equation (6).

A fifth image and a sixth image with the second sample types are included in the plurality of first state images. A third magnitude relationship between a first reward value corresponding to the fifth image and a first reward value corresponding to the sixth image may be determined, and a third sub-loss value may be determined by a third sub-loss function in the first loss function based on the third magnitude relationship.

Exemplarily, a first state image generated prior to the successful performing of the target task may also be referred to as a negative sample. The fifth image and the sixth image, both of which have the second sample types, may be the first state image generated from unsuccessful trajectory τⁿ, that is, the fifth image and the sixth image are negative samples. It is taken that the fifth image is a negative sample

$${O}_{i}^{n}$$

and the sixth image is a negative sample

$${O}_{j}^{p}$$

In order that the successful trajectory may be learned earlier, the goal image O_{g} corresponding to the successful performing of the target task may be utilized to accelerate the learning. A distance between the negative sample

$${O}_{i}^{n}$$

and the goal image O_{g} and the distance between the negative sample

$${O}_{j}^{n}$$

and the goal image O_{g} may be determined. Since the reward value for the negative sample which is the closer to the goal image O_{g} shall be the higher, the third sub-loss value [symbol] _{neg-neg} may be determined by further comparing the reward value for the negative sample

$${O}_{i}^{n}$$

and the reward value for the negative sample

$${O}_{j}^{n}$$

after the distances or the negative sample and negative sample

$${O}_{i}^{n}$$

and negative sample

$${O}_{j}^{n}$$

to the goal image O_{g} are determined.

The value of the third sub-loss [symbol] _{neg-neg} may be determined by Equation (8)-Equation (10) below.

$$\begin{matrix}E \\ {ℒ}_{n e g - n e g} = {\{ {O}_{i}^{n} , {O}_{i}^{n} ∈ {τ}^{n} {L}_{2} ( {O}_{i}^{n} , {O}_{g} ) < {L}_{2} ( {O}_{j}^{n} , {O}_{g} ) - {δ}^{′} \}}^{{ℓ}_{δ} ( {O}_{i}^{n} , {O}_{j}^{n} )}\end{matrix} \qquad Equation ( 8 )$$

$${L}_{2} ( O , {O}_{g} ) {=}^{Δ} {‖ {∅}_{I} ( O ) - {∅}_{I} ( {O}_{g} ) ‖}_{2} \qquad Equation ( 9 )$$

$${ℓ}_{δ} ( {O}_{i}^{n} , {O}_{j}^{n} ) {=}^{Δ} max ( 0 , {r}^{V L M} ( {O}_{j}^{n} ) - {r}^{V L M} ( {O}_{i}^{n} ) + δ ) \qquad Equation ( 10 )$$

where

$${r}^{V L M} ( {O}_{i}^{n} )$$

denotes the reward value for the negative sample

$${O}_{i}^{n} , and {r}^{V L M} ( {O}_{j}^{n} )$$

denotes the reward value for the negative sample

$${O}_{j}^{n} ,$$

and O_{g} denotes the goal image when the target task is performed successfully.

In a case that the distance

$${L}_{2} ( {O}_{i}^{n} , {O}_{g} )$$

between the negative sample

$${O}_{i}^{n}$$

and the goal image O_{g} is less than, by δ′, the distance

$${L}_{2} ( {O}_{j}^{n} , {O}_{g} )$$

between the negative sample

$${O}_{j}^{n}$$

and the goal image O_{g}, when the reward value

$${r}^{V L M} ( {O}_{j}^{n} )$$

for the negative sample

$${O}_{j}^{n}$$

is less than, by δ, the reward value

$${r}^{V L M} ( {O}_{i}^{n} )$$

for the negative sample

$${O}_{i}^{n} ,$$

no loss may occur, and otherwise a loss may occur.

For example, in the case that the distance

$${L}_{2} ( {O}_{i}^{n} , {O}_{g} )$$

between the negative sample

$${O}_{i}^{n}$$

and the goal image O_{g} is less than, by δ′, the distance

$${L}_{2} ( {O}_{j}^{n} , {O}_{g} )$$

between the negative sample

$${O}_{j}^{n}$$

and the goal image O_{g}, when a difference between the reward value

$${r}^{VLM} ( {O}_{i}^{n} )$$

for the negative sample

$${r}^{VLM} ( {O}_{j}^{n} )$$

and the reward value

$${O}_{i}^{n}$$

for the negative sample

$${O}_{j}^{n}$$

is greater than δ, no loss may occur (i.e., the loss value is 0); and when a difference between the reward value

$${r}^{VLM} ( {O}_{i}^{n} )$$

for the negative sample

$${O}_{i}^{n}$$

and the reward value

$${r}^{VLM} ( {O}_{j}^{n} )$$

for the negative sample

$${O}_{j}^{n}$$

is less than δ, a loss may occur (i.e., the loss value is not 0). The third sub-loss value [symbol] _{neg-neg} may be calculated by the above Equation (8).

In some examples, the loss value determined in step S30331 may include at least one of a first sub-loss value [symbol] _{pos-neg}, a second sub-loss value [symbol] ₚₒₛ₋ₚₒₛ and a third sub-loss value [symbol] _{neg-neg}, and after the first sub-loss value [symbol] _{pos-neg}, the second sub-loss value [symbol] ₚₒₛ₋ₚₒₛ and the third sub-loss value [symbol] _{neg-neg} are determined, the loss value [symbol] may be determined based on the first sub-loss value [symbol] _{pos-neg}, the second sub-loss value [symbol] ₚₒₛ₋ₚₒₛ and the third sub-loss value [symbol] _{neg-neg}.

The loss value [symbol] may be determined by Equation (11) below.

$$ℒ = {ℒ}_{p o s - n e g} + {ℒ}_{p o s - p o s} + {ℒ}_{n e g - n e g} \qquad Equation ( 11 )$$

It should be noted that in the early stage of the performing of the target task, since the target task has not been successfully performed (that is, there is no successful trajectory yet), the generated first state images are all negative samples, and then, the first state images read from the memory are all negative samples, and the third sub-loss value [symbol] _{neg-neg} between the negative samples may be determined by the above mentioned (8)-Equation (10). With the performing of the target task, when the target task is performed successfully, the samples stored in the memory may include positive samples, and the second sub-loss value [symbol] ₚₒₛ₋ₚₒₛ between the positive samples may be determined by Equation (6) and Equation (7) above. The agent may perform the target task more than one time, and the target task may or may not be successfully performed, so the first state image stored in the memory may include both positive and negative samples, and the first sub-loss value [symbol] _{pos-neg} between the positive and negative samples may be determined by the above Equation (4) and Equation (5).

Step S30332: adjusting weight parameters for an image optimization network and a text optimization network in the optimization submodel based on the loss value.

After the loss value is determined, the weight parameters for the image optimization network f_{WI} and the text optimization network f_{WL} in the optimization submodel may be adjusted based on the loss value so that the adjusted reward model may more accurately describe the process for performing the task.

Before the weight parameters for the image optimization network f_{WI} and the text optimization network f_{WL} are adjusted, the reward value for the negative sample determined according to the reward model may be higher than the reward value for the positive sample, that is, the reward value determined according to the reward model may not be well aligned with the task progress. After the weight parameters for the image optimization network f_{WI} and the text optimization network f_{WL} are adjusted according to the loss value, it may be ensured that the reward value corresponding to the first state image among the reward values determined according to the adjusted reward model is higher as the task gets closer to a success state. Since more accurate reward values can be determined by the adjusted reward model, the reinforcement learning based on the adjusted reward model may ensure that more accurate policy parameters are learned.

According to the embodiments of the present disclosure, the reward values corresponding to the first state images of the respective sample types may be compared, and at least one of a first sub-loss value [symbol] _{pos-neg} between the positive and negative samples, a second sub-loss value between the positive samples [symbol] ₚₒₛ₋ₚₒₛ and a third sub-loss value [symbol] _{neg-neg} between the negative samples may be determined based on the comparison results, and the weight parameters for the image optimization network and the text optimization network in the optimization submodel may be adjusted based on at least one of the first to third sub-loss values, then it may be ensured that the adjusted reward model may more accurately describe the process for performing the task.

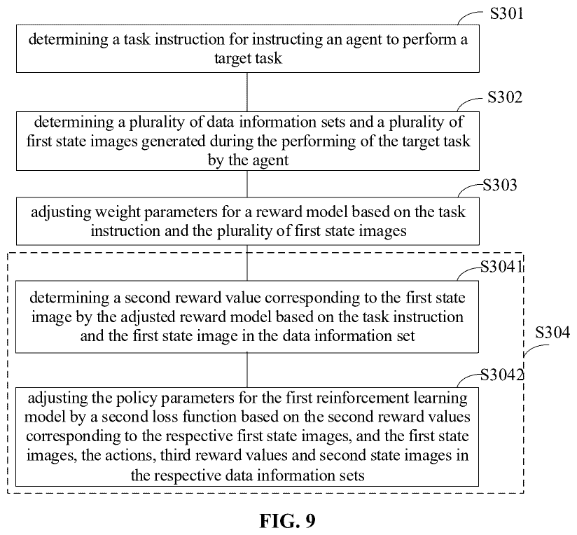

As shown in FIG. 9, based on the embodiment shown in FIG. 3 above, step S304 may include step S3041-step S3043 below.

Step S3041: determining a second reward value corresponding to the first state image by the adjusted reward model based on the task instruction and the first state image in the data information set.

In some embodiments, during training of the first reinforcement learning model, the data information set for the target task during the performing may be randomly read from the memory.

Exemplarily, step S3041 includes: determining a corresponding image vector and a corresponding text vector by a visual language submodel in the adjusted reward model based on the task instruction and the first state image in the task instruction set; and determining the second reward value corresponding to the first state image by an optimization submodel in the adjusted reward model based on the image vector and the text vector.

Since the reward model includes the visual language submodel and the optimization submodel, and in the above step S303 the weight parameter for the visual language submodel is not adjusted but the weight parameter for the optimization submodel is adjusted, when the adjusted reward model is used to determine the second reward value corresponding to the first state image, the task instruction and the first state image in data information set may be processed according to the visual language submodel to obtain the corresponding image vector and text vector; and then the text vector and the image vector by the adjusted optimization submodel processes to obtain the second reward value corresponding to the first state image.

It should be noted that since the present disclosure embodiment may not adjust the weight parameter for the visual language submodel, and the task instructions for performing the same target tasks by the agent are the same, the text vector determined according to the visual language submodel are also the same. Therefore, in the method for reinforcement learning a model in accordance with the disclosed embodiments, it is possible to process the task instruction once by a text encoder in the visual language submodel. Of course, it is also possible to process the task instruction by the text encoder in the visual language submodel whenever determining the first reward value and the second reward value, which is not limited to the embodiments of the present application.

Exemplarily, the determining a second reward value corresponding to the first state image by an optimization submodel in the adjusted reward model based on the image vector and the text vectors includes: determining a second image optimization vector based on the image vector and an image optimization network in the adjusted optimization submodel; and determining a second text optimization vector based on the text vector and a text optimization network in the adjusted optimization submodel; and determining the second reward value corresponding to the first state image based on the second image optimization vector and the second text optimization vector.

Because the optimization submodel includes two small learnable networks, namely, the image optimization network f_{WI} and the text optimization network f_{WL}, respectively, after the image vector and the text vector are obtained according to the visual language submodel, the image vector may be processed according to the image optimization network f_{WI} in the adjusted optimization submodel to obtain the second image optimization vector, the text vector may be processed according to the text optimization network f_{WL} in the adjusted optimization submodel to obtain the second text optimization vector, and then a cosine similarity between the second image optimization vector and the second text optimization vector may be calculated to obtain the second reward value corresponding to the first state image.

It is to be understood that the specific implementation of determining the second reward value corresponding to the first state image based on the adjusted reward model may be referred to the aforementioned step S3031-step S3032, which are not repeated herein.

Because the second reward value determined by the adjusted reward model is more accurate than the first reward value determined by the pre-adjusted reward model, it may be ensured that the learned policy parameters are more accurate when performing reinforcement learning based on the second reward value.

Step S3042: adjusting the policy parameters for the first reinforcement learning model by a second loss function based on the second reward values corresponding to the respective first state images, and the first state images, the actions, third reward values and second state images in the respective data information sets.

Exemplarily, in the process of training the first reinforcement learning model, a batch of data information sets may be randomly read from the memory at each iteration, which may include a set of N second state images (i.e., current state images), actions, reward values, and first state images (i.e., next state images), notated as {(Sᵢ, Aᵢ, Rᵢ₊₁, Sᵢ₊₁)}_{i=0 . . . . N}. Then, the policy parameters for the first reinforcement learning model are adjusted by the second loss function based on these second state images, actions, reward values and first state images. The process is iterated until a cumulative reward value reaches a preset condition and then the first reinforcement learning model training is completed.

Exemplarily, the third reward value in the data information set may be a sparse task reward

$${r}_{t}^{task} .$$

The reward value r^{t} during training of the first reinforcement learning model may be determined based on both the sparse task reward

$${r}_{t}^{task}$$

and the VLM reward

$${r}_{t}^{VLM} .$$

This VLM reward

$${r}_{t}^{VLM}$$

is the second reward value determined based on the adjusted reward model. For example, the reward value

$${r}^{t} = {r}_{t}^{task} + ρ \cdot {r}_{t}^{VLM} .$$

In some examples, the cumulative reward value reaching a predetermined condition includes: the cumulative reward value is greater than a predetermined threshold, or, the cumulative reward value reaches a maximum. Embodiments of the present disclosure do not limit the content of the preset condition, and the policy when the cumulative reward value reaches a maximum may be referred to as an optimal policy.

Embodiments of the present disclosure determine the second reward value by the adjusted reward model, and the second reward value determined by the adjusted reward model is more accurate since the adjusted reward model may more accurately describe the process for performing the task compared to the pre-adjusted reward model. Thereby, when training the first reinforcement learning model based on the more accurate second reward value, it is possible to ensure that more accurate policy parameters are learned.

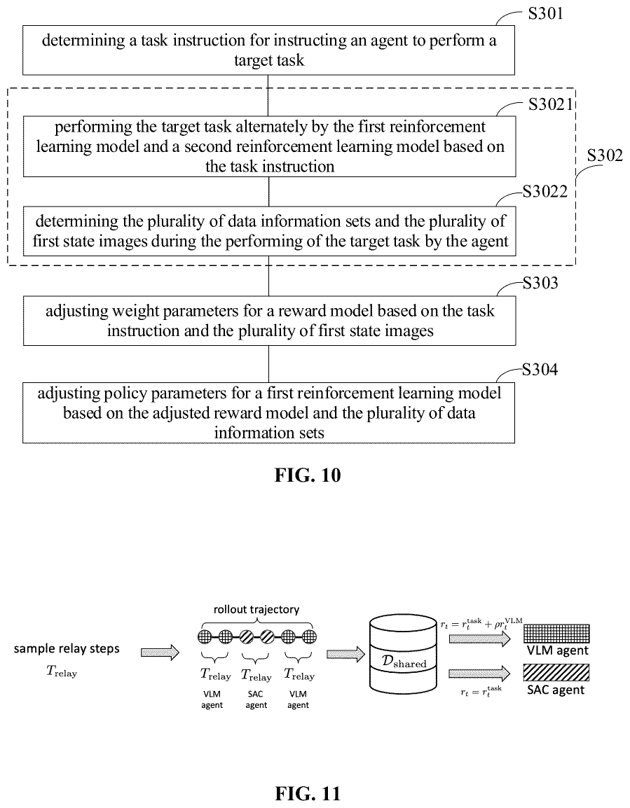

As shown in FIG. 10, based on the embodiment shown in FIG. 3 above, step S302 may include step S3021-step S3022 as follows.

Step S3021: performing the target task alternately by the first reinforcement learning model and a second reinforcement learning model based on the task instruction.

Exemplarily, the first reinforcement learning model and the second reinforcement learning model may be different reinforcement learning models. The first reinforcement learning model may be implemented by a VLM agent (i.e., an agent by training for reinforcement learning by using VLM+task rewards), and may have a reward function corresponding to the aforementioned reward model. The second reinforcement learning model may be implemented by a SAC agent (i.e., an agent by training for reinforcement learning by using only task rewards based the SAC algorithm), and may have a reward function corresponding to the sparse task reward.

In the process of training the first reinforcement learning model, in order to avoid the problem that the successful trajectories according to the performing of the target task by the agent cannot be collected because inaccurate VLM reward values determined by the reward model could trap the agent in a local minimum, the first reinforcement learning model and the second reinforcement learning may be used to perform the target task alternately in order to increase the diversity of data collection.

When the first reinforcement learning model and the second reinforcement learning model are used to perform the target task alternately, a sample relay step T_{relay} may be pre-selected before the performing of the target task starts and the first reinforcement learning model and the second reinforcement learning model may be alternately used to perform the target task by the sample relay step T_{relay}.

For example, with taking the sample relay step T_{relay} as 50 as an example, the first reinforcement learning model and the second reinforcement learning model may be alternately used to perform the target task per 50 steps. As shown in FIG. 11, the first reinforcement learning model VLM agent may be used to perform the target task in the first 50 steps, the second reinforcement learning model SAC agent may be used to perform the target task from the 51st to the 100th steps, and the first reinforcement learning model VLM agent may be used to perform the target task from the 101st to the 150th steps once more, and so on, which are alternately used to perform the target task until the target task is performed successfully. The data collected during the alternating performing of the target task by using the first reinforcement learning model and the second reinforcement learning model may be stored in a shared buffer D_{shared}, and the data may be read from the shared buffer D_{shared} for training on the VLM agent and the SAC agent during the subsequent reinforcement learning process.

As shown in FIG. 11, the reward function used in training the first reinforcement learning model is different from the reward function used in the second reinforcement learning model. In this case, the VLM reward values in the reward function used for the first reinforcement learning model is determined based on the reward model.

In some examples, after the target task is performed alternately using the first reinforcement learning model and the second reinforcement learning model and the success trajectory is collected, the preforming may no longer be alternate. That is, after the success trajectory is collected, data generated during the performing of the target task may be collected by only the first reinforcement learning model.

Step S3022: determining the plurality of data information sets and the plurality of first state images during the performing of the target task by the agent.

Exemplarily, when the agent performs the target task by using the first reinforcement learning model and the second reinforcement learning model alternately, the plurality of data information sets and the first state image collected include both data collected using the VLM policy and data collected using the SAC policy. During subsequent training of the first reinforcement learning model, the data information sets may be randomly read from the memory, which may be data collected using the VLM policy or data collected using the SAC policy, and the embodiments of the present application do not limit them.

According to the embodiments of the present disclosure, by using the first reinforcement learning model and the second reinforcement learning model to perform the target task alternately for data collection, more diverse data can be collected in order to solve the problem that the successful trajectories according to the performing of the target task by the agent cannot be collected because inaccurate VLM reward values determined by the reward model could trap the agent in a local minimum.

### Exemplary Apparatus

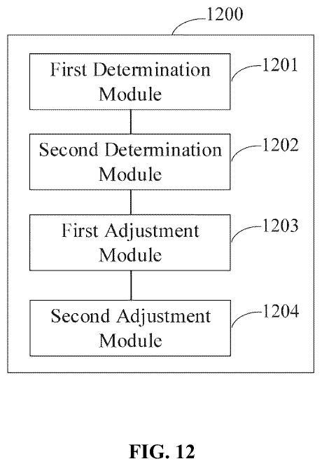

FIG. 12 shows an apparatus for training a reinforcement learning model in accordance with embodiments of the present disclosure. As shown in FIG. 12, the apparatus 1200 for the reinforcement learning model includes a first determination module 1201, a second determination module 1202, a first adjustment module 1203, and a second adjustment module 1204.

The first determination module 1201 is configured for determining a task instruction for instructing an agent to perform a target task.

The second determination module 1202 is configured for determining a plurality of data information sets and a plurality of first state images generated during the performing of the target task by the agent.

The first adjustment module 1203 is configured for adjusting weight parameters for a reward model based on the task instruction and the plurality of first state images.

The second adjustment module 1204 is configured for adjusting policy parameters for a first reinforcement learning model based on the adjusted reward model and the plurality of data information sets.

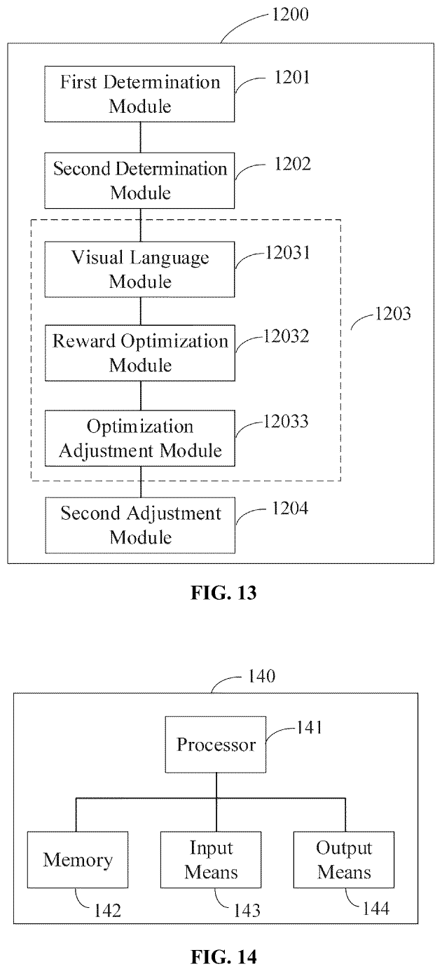

In some embodiments, as shown in FIG. 13, the first adjustment module 1203 includes a visual language module 12031, a reward optimization module 12032, and an optimization adjustment module 12033.

The visual language module 12031 is configured for determining a corresponding image vector and a corresponding text vector by a visual language submodel in the reward model based on the task instruction and the first state image.

The reward optimization module 12032 is configured for determining a first reward value corresponding to the first state image by an optimization submodel in the reward model based on the image vector and the text vector.

The optimization adjustment module 12033 is configured for adjusting weight parameters for the optimization submodel based on the first reward values corresponding to the plurality of first state images.

In some embodiments, the reward optimization module 12032 is configured for processing the image vector based on an image optimization network in the optimization submodel to obtain a first image optimization vector, processing the text vector based on a text optimization network in the optimization submodel to obtain a first text optimization vector, and determining the first reward value corresponding to the first state image based on the first image optimization vector and the first text optimization vector.

In some embodiments, the optimization adjustment module 12033 is configured for determining a loss value based on the first reward values corresponding to the plurality of first state images and the first loss function, and adjusting weight parameters for the image optimization network and the text optimization network in the optimization submodel based on the loss value.

In some embodiments, the optimization adjustment module 12033 is configured for determining a sample type of each of the first state images; determining, in response to the plurality of first state images including a first image with a first sample type and a second image with a second sample type, a first magnitude relationship between a first reward value corresponding to the first image and a first reward value corresponding to the second image, and determining a first sub-loss value by a first sub-loss function in the first loss function based on the first magnitude relationship; and/or determining, in response to the plurality of first state images including a third image and a fourth image of the first sample types, a second magnitude relationship between a first reward value corresponding to the third image and a first reward value corresponding to the fourth image, and determining a second sub-loss value by a second sub-loss function in the first loss function based on the second magnitude relationship; and/or determining, in response to the plurality of the first state images including a fifth image and a sixth image with the second sample types, a third magnitude relationship between a first reward value corresponding to the fifth image and a first reward value corresponding to the sixth image, and determining a third sub-loss value by a third sub-loss function in the first loss function based on the third magnitude relationship; and determining a loss value based on at least one of the first sub-loss value, the second sub-loss value, and the third sub-loss value.

In some embodiments, the second adjustment module 1204 is specifically configured for determining a second reward value corresponding to the first state image by the adjusted reward model based on the task instruction and the first state image in the data information set; and adjusting the policy parameters for the first reinforcement learning model by a second loss function based on the second reward values corresponding to the respective first state images, the first state images, the action, a third reward value, and the second state image in the respective data information sets.

In some embodiments, the second adjustment module 1204 is specifically configured for determining a corresponding image vector and a corresponding text vector by a visual language submodel in the adjusted reward model based on the task instruction and the first state image in the data information set; and determining a second reward value corresponding to the first state image by an optimization submodel in the adjusted reward model based on the image vector and the text vector.

In some embodiments, the second adjustment module 1204 is specifically configured for determining a second image optimization vector based on the image vector and the image optimization network in the adjusted optimization submodel, determining a second text optimization vector based on the text vector and the text optimization network in the adjusted optimization submodel, and determining the second reward corresponding to the first state image value based on the second image optimization vector and the second text optimization vector.

In some embodiments, the second determination module 1202, is specifically configured for performing a target task alternately by the first reinforcement learning model and the second reinforcement learning model based on the task instruction; and determining the plurality of data information sets and the plurality of first state images during the performing of the target task by the agent.

Beneficial technical effects corresponding to the above exemplary embodiment of the apparatus 1200 for training a reinforcement learning model may be found in the corresponding beneficial technical effects of the above exemplary method, which is not repeated herein.

### Exemplary Electronic Device

FIG. 14 shows a schematic diagram illustrating a structure of an electronic device 140 in accordance with embodiments of the present disclosure, including at least one processor 141 and a memory 142.

The processor 141 may be a central processing unit (CPU) or another form of processing unit having data processing capabilities and/or instruction execution capabilities, and may control other components in the electronic device 120 to implement desired functions.

The memory 142 may include one or more computer program products. The computer program product may include various forms of computer readable storage media, such as a volatile memory and/or a non-volatile memory. The volatile memory may include, for example, a random access memory (RAM), a cache and/or the like. The nonvolatile memory may include, for example, a read-only memory (ROM), a hard disk, a flash memory and the like. One or more computer program instructions may be stored on the computer readable storage medium. The program instruction may be executed by the processor 141, to implement the method for training a reinforcement learning model according to the respective embodiments of the present disclosure described above and/or other desired functionality.

In an example, the electronic device 140 may further include an input means 143 and an output means 144. These components are interconnected with each other through a bus system and/or another form of connection mechanism (not shown).

The input means 143 may further include, for example, a keyboard, a mouse and so on.

The output means 144 may output various information to outside, and may include, for example, a display, a loudspeaker, a printer, a communication network, a remote output means connected by the communication network, and so on.

Of course, for the sake of simplicity, only some of the components in the electronic device 140 that are related to the present disclosure are shown in FIG. 14, and components such as a bus and an input/output interface are omitted. In addition, according to specific application situations, the electronic device 140 may further include any other appropriate components.

### Exemplary Computer Program Product and Computer Readable Storage Medium

In addition to the foregoing method and device, the embodiments of the present disclosure may further relate to a computer program product, including a computer program instruction that, when run by a processor, cause the processor to implement the steps in the method for training a reinforcement learning model according to the embodiments of the present disclosure, that are described in the section “Exemplary Method” of this specification.

The computer program product may be program codes, written with one or any combination of a plurality of programming languages, that are configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer-readable storage medium, which stores a computer program instruction. When executing the computer program instruction that, when run by a processor, cause the processor to perform the steps in the method for training a reinforcement learning model according to the embodiments of the present disclosure, that are described in the section “Exemplary Method” of this specification.

The computer-readable storage medium may be one readable medium or any combination of a plurality of readable media. The readable medium may be a readable signal medium or a readable storage medium. The readable storage medium may include, for example, but is not limited to electricity, magnetism, light, electromagnetism, infrared ray, or a semiconductor system, apparatus or device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or flash memory) or a flash memory, an optical fiber, a portable compact disk read-only memory (CD-ROM), an optical storage device, a magnetic storage device, or any suitable combination of the above.

Basic principles of the present disclosure are described above in combination with the specific embodiments. However, it should be pointed out that the advantages, superiorities, and effects mentioned in the present disclosure are merely illustrative but are not for limitation, and it cannot be considered that these advantages, superiorities, and effects are necessary for each embodiment of the present disclosure. In addition, specific details of the above disclosure are merely for examples and for ease of understanding, rather than limitations. The foregoing details do not limit that the present disclosure must be implemented by using the foregoing specific details.

A person skilled in the art may make various changes and variations to the present disclosure without departing from the spirit and scope of the present application. It should be noted that the scope of the present disclosure is defined by the accompanying claims, rather than by the foregoing detailed descriptions, and all changes or modifications derived from the meaning and scope of the claims and equivalents thereof are included in the scope of the present disclosure.

What is claimed is:

1. A method for training a reinforcement learning model, including:
determining a task instruction for instructing an agent to perform a target task;
determining a plurality of data information sets and a plurality of first state images generated during the performing of the target task by the agent;
adjusting weight parameters for a reward model based on the task instruction and the plurality of first state images;
adjusting policy parameters for a first reinforcement learning model based on the adjusted the reward model and the plurality of data information sets.

2. The method according to claim 1, wherein the adjusting weight parameters for a reward model based on the task instruction and the plurality of first state images includes:
determining a corresponding image vector and a corresponding text vector by a visual language submodel in the reward model based on the task instruction and the first state image; and
determining a first reward value corresponding to the first state image by an optimization submodel in the reward model based on the image vector and the text vector;
adjusting weight parameters for the optimization submodel based on the first reward values corresponding to the plurality of the first state images.

3. The method according to claim 2, wherein the determining a first reward value corresponding to the first state image by an optimization submodel in the reward model based on the image vector and the text vector includes:
processing the image vector based on an image optimization network in the optimization submodel to obtain a first image optimization vector;
processing the text vector based on a text optimization network in the optimization submodel to obtain a first text optimization vector;
determining the first reward value corresponding to the first state image based on the first image optimization vector and the first text optimization vector.

4. The method according to claim 2, wherein the adjusting weight parameters for the optimization submodel based on the first reward values corresponding to the plurality of the first state images includes:
determining a loss value based on the first reward values corresponding to the plurality of the first state images and a first loss function; and
adjusting weight parameters for an image optimization network and a text optimization network in the optimization submodel based on the loss value.

5. The method according to claim 4, wherein the determining a loss value based on the first reward values corresponding to the plurality of first state images and a first loss function includes:
determining a sample type for each of the first state images;
determining, in response to the plurality of first state images including a first image with a first sample type and a second image with a second sample type, a first magnitude relationship between a first reward value corresponding to the first image and a first reward value corresponding to the second image, and determining a first sub-loss value by a first sub-loss function in the first loss function based on the first magnitude relationship; and/or
determining, in response to the plurality of first state images including a third image and a fourth image of the first sample types, a second magnitude relationship between a first reward value corresponding to the third image and a first reward value corresponding to the fourth image, and determining a second sub-loss value by a second sub-loss function in the first loss function based on the second magnitude relationship; and/or
determining, in response to the plurality of the first state images including a fifth image and a sixth image with the second sample types, a third magnitude relationship between a first reward value corresponding to the fifth image and a first reward value corresponding to the sixth image, and determining a third sub-loss value by a third sub-loss function in the first loss function based on the third magnitude relationship; and
determining the loss value based on at least one of the first sub-loss value, the second sub-loss value, and the third sub-loss value.

6. The method according to claim 1, wherein the adjusting policy parameters for a first reinforcement learning model based on the adjusted the reward model and the plurality of data information sets includes:
determining a second reward value corresponding to the first state image by the adjusted reward model based on the task instruction and the first state image in the data information set;
adjusting the policy parameters for the first reinforcement learning model by a second loss function based on the second reward values corresponding to the respective first state images, and the first state images, the actions, third reward values and second state images in the respective data information sets.

7. The method according to claim 6, wherein the determining a second reward value corresponding to the first state image by the adjusted reward model based on the task instruction and the first state image in the data information set includes:
determining a corresponding image vector and a corresponding text vector by a visual language submodel in the adjusted reward model based on the task instruction and the first state image in the data information set; and
determining the second reward value corresponding to the first state image by an optimization submodel in the adjusted reward model based on the image vector and the text vector.

8. The method according to claim 7, wherein the determining the second reward value corresponding to the first state image by an optimization submodel in the adjusted reward model based on the image vector and the text vector includes:
determining a second image optimization vector based on the image vector and an image optimization network in the adjusted optimization submodel;
determining a second text optimization vector based on the text vector and a text optimization network in the adjusted optimization submodel; and
determining the second reward value corresponding to the first state image based on the second image optimization vector and the second text optimization vector.

9. The method according to claim 1, the determining a plurality of data information sets and a plurality of first state images generated during the performing of the target task by the agent includes:
performing the target task alternately by the first reinforcement learning model and a second reinforcement learning model based on the task instruction; and
determining the plurality of data information sets and the plurality of first state images during the performing of the target task by the agent.

10. A non-transitory computer-readable storage medium, on which a computer program is stored, wherein the computer program is configured to implement a method for training a reinforcement learning model, including:
determining a task instruction for instructing an agent to perform a target task;
determining a plurality of data information sets and a plurality of first state images generated during the performing of the target task by the agent;
adjusting weight parameters for a reward model based on the task instruction and the plurality of first state images;
adjusting policy parameters for a first reinforcement learning model based on the adjusted the reward model and the plurality of data information sets.

11. The non-transitory computer-readable storage medium according to claim 10, wherein the adjusting weight parameters for a reward model based on the task instruction and the plurality of first state images includes:
determining a corresponding image vector and a corresponding text vector by a visual language submodel in the reward model based on the task instruction and the first state image; and
determining a first reward value corresponding to the first state image by an optimization submodel in the reward model based on the image vector and the text vector;
adjusting weight parameters for the optimization submodel based on the first reward values corresponding to the plurality of the first state images.

12. The non-transitory computer-readable storage medium according to claim 11, wherein the determining a first reward value corresponding to the first state image by an optimization submodel in the reward model based on the image vector and the text vector includes:
processing the image vector based on an image optimization network in the optimization submodel to obtain a first image optimization vector;
processing the text vector based on a text optimization network in the optimization submodel to obtain a first text optimization vector;
determining the first reward value corresponding to the first state image based on the first image optimization vector and the first text optimization vector.

13. The non-transitory computer-readable storage medium according to claim 11, wherein the adjusting weight parameters for the optimization submodel based on the first reward values corresponding to the plurality of the first state images includes:
determining a loss value based on the first reward values corresponding to the plurality of the first state images and a first loss function; and
adjusting weight parameters for an image optimization network and a text optimization network in the optimization submodel based on the loss value.

14. The non-transitory computer-readable storage medium according to claim 10, wherein the adjusting policy parameters for a first reinforcement learning model based on the adjusted the reward model and the plurality of data information sets includes:
determining a second reward value corresponding to the first state image by the adjusted reward model based on the task instruction and the first state image in the data information set;
adjusting the policy parameters for the first reinforcement learning model by a second loss function based on the second reward values corresponding to the respective first state images, and the first state images, the actions, third reward values and second state images in the respective data information sets.

15. The non-transitory computer-readable storage medium according to claim 10, the determining a plurality of data information sets and a plurality of first state images generated during the performing of the target task by the agent includes:
performing the target task alternately by the first reinforcement learning model and a second reinforcement learning model based on the task instruction; and
determining the plurality of data information sets and the plurality of first state images during the performing of the target task by the agent.

16. An electronic device, including:
a processor;
a memory configured for storing processor-executable instructions;
wherein the processor is configured for reading the executable instruction from the memory, and executing the instruction to implement a method for training a reinforcement learning model, including:
determining a task instruction for instructing an agent to perform a target task;
determining a plurality of data information sets and a plurality of first state images generated during the performing of the target task by the agent;
adjusting weight parameters for a reward model based on the task instruction and the plurality of first state images;
adjusting policy parameters for a first reinforcement learning model based on the adjusted the reward model and the plurality of data information sets.

17. The electronic device according to claim 16, wherein the adjusting weight parameters for a reward model based on the task instruction and the plurality of first state images includes:
determining a corresponding image vector and a corresponding text vector by a visual language submodel in the reward model based on the task instruction and the first state image; and
determining a first reward value corresponding to the first state image by an optimization submodel in the reward model based on the image vector and the text vector;
adjusting weight parameters for the optimization submodel based on the first reward values corresponding to the plurality of the first state images.

18. The electronic device according to claim 17, wherein the determining a first reward value corresponding to the first state image by an optimization submodel in the reward model based on the image vector and the text vector includes:
processing the image vector based on an image optimization network in the optimization submodel to obtain a first image optimization vector;
processing the text vector based on a text optimization network in the optimization submodel to obtain a first text optimization vector;
determining the first reward value corresponding to the first state image based on the first image optimization vector and the first text optimization vector.

19. The electronic device according to claim 16, wherein the adjusting policy parameters for a first reinforcement learning model based on the adjusted the reward model and the plurality of data information sets includes:
determining a second reward value corresponding to the first state image by the adjusted reward model based on the task instruction and the first state image in the data information set;
adjusting the policy parameters for the first reinforcement learning model by a second loss function based on the second reward values corresponding to the respective first state images, and the first state images, the actions, third reward values and second state images in the respective data information sets.

20. The electronic device according to claim 16, the determining a plurality of data information sets and a plurality of first state images generated during the performing of the target task by the agent includes:
performing the target task alternately by the first reinforcement learning model and a second reinforcement learning model based on the task instruction; and
determining the plurality of data information sets and the plurality of first state images during the performing of the target task by the agent.
